(19) United States
(12) Patent Application Publication
(10) Pub. No.: US 2017/0335983 A1
(43) Pub. Date: Nov. 23, 2017

(54) VALVE ASSEMBLY

(71) Applicant: S.P.A. Automotive Limited, Nr. Lichfield (GB)

(72) Inventors: Richard BARNES, Nr. Lichfield (GB); Steven HAWKINS, Nr. Lichfield (GB); Tony TAYLOR, Nr. Lichfield (GB)

(21) Appl. No.: 15/159,952

(22) Filed: May 20, 2016

(51) Int. Cl. F16K 17/38; F16K 31/12; A62C 37/36; F16K 31/04; F16K 35/06; F16K 31/46

(52) U.S. Cl. CPC F16K 17/38; F16K 35/06; F16K 31/465; A62C 37/36; F16K 31/04; F16K 31/12

(57) ABSTRACT

A valve assembly for controlling the release or delivery of a fire suppression medium from a vessel, the assembly comprising an inlet connectable to a pressurised vessel, an outlet connectable to a delivery device, a valve operable to selectively open or close fluid communication between the inlet and the outlet, an opening device for moving the valve from a closed condition to an open condition, first and second actuators and an environmental triggering device, wherein the opening device is operable, in use, remotely by the first actuator or manually by the second actuator or automatically by the environmental triggering device. A fire suppression system employing the above-described valve and a vehicle including the fire suppression system also form a part of this invention.

### BACKGROUND OF THE INVENTION

### 1. Field of Invention

This invention relates generally to a valve assembly and more particularly to a valve assembly for enabling controlled release or delivery of a fluid or other medium. More specifically, although not exclusively, this invention relates to a valve assembly for incorporation into the delivery device of a pressurised vessel, such as fire extinguishers and the like, for us in emergency equipment, e.g., emergency vehicles.

### 2. Description of Related Art

Valve assemblies for emergency equipment are generally controlled manually, for example as described in WO2008/154718 or automatically, for example as described in EP0033062 or U.S. Pat. No. 6,341,616. Hand-held fire extinguishers, for example, are well known and normally include a safety pin that is pulled or removed to enable manual actuation of a scissor-like handle, which selectively releases the extinguishing medium on actuation. In motorsport, vehicles are sometimes fitted with fire suppression systems that incorporate both a thermal head, which is activated automatically for enhanced safety, and a manual actuator for a driver to trigger the release of fire extinguishing medium if the thermal head has not triggered.

However, fire events in motorsport can often be sudden, where reaction time of an emergency response is crucial. In such cases, it can be difficult or cumbersome to access and actuate the manual actuator, which can have serious or even fatal consequences.

### OBJECTS AND SUMMARY OF INVENTION

It is therefore a first non-exclusive object of the invention to provide a valve assembly for a pressure vessel that overcomes or at least mitigates the issues associated with prior art valve assemblies. It is a further, more general non-exclusive object of the invention to provide an improved valve assembly.

Accordingly, a first aspect of the invention provides a valve assembly, e.g. for a fire suppression system and/or for controlling the release or delivery of a fluid or other medium from a vessel, the valve assembly comprising an inlet, e.g. for or connectable to a vessel or pressurised vessel, an outlet, e.g. connectable to a delivery means, valve means operable to selectively open or close fluid communication between the inlet and the outlet and opening means for moving or changing the valve means from a closed position or condition to an open position or condition, wherein the opening means is operable remotely and/or manually and/or automatically.

In some embodiments, the opening means comprises two or more, e.g. three, opening means. The opening means or a first opening means may be activated or triggered remotely and/or may comprise a first and/or remote input means or actuator, e.g. a button or switch or keypad or touchscreen, which may operate the opening means electrically or by a fluid and/or may be operatively connected, e.g. electrically or pneumatically or hydraulically connected, to the valve means. For example, the opening means or first opening means may comprise a percussive or explosive means or charge or an electromagnetic or electromechanical means or actuator, e.g. a servo actuator or motor, which may receive and/or be triggered by a signal, e.g. an electrical signal, from the remote input means. In some embodiments, the percussive or explosive means or charge or the electromagnetic or electromechanical means or actuator may be replaced with a fluid powered means or actuator, such as a pneumatic or hydraulic means or actuator, which may receive a fluid-powered or electrical signal from the remote input means. The opening means or a second opening means may additionally or alternatively be activated or triggered manually and/or may comprise a second and/or manual override or actuator that may operate the opening means mechanically or by a cable, which may be slidable within a sheath, or a rod or shaft and/or may be operatively connected, e.g. mechanically connected such as by a cable or rod or shaft, to the valve means. The opening means or a third opening means may comprise an environmental triggering means and/or may be activated or triggered automatically, for example environmentally activated or triggered, e.g. temperature activated or triggered.

The provision of three means for opening the valve has been found to enable the fire suppression system to be configured such that the response time required to react to a fire is greatly reduced.

The valve means may be biased to or toward the open position or condition. Alternatively, the valve means may be biased, in use, toward the closed position or condition.

The valve assembly or opening means may further comprise a release means or abutment means, e.g. for selectively retaining the valve means in the closed position or condition and/or for selectively allowing the valve means to move from the closed position or condition to or toward the open position or condition. The release means or abutment means may comprise a release element or member or device and/or may be breakable or frangible or severable or movable or changeable, for example in response to the actuation of one or each of the first and/or second opening means or actuators and/or in response to the third opening means or automatic triggering means. The release means or abutment means may be changeable or movable between a deployed or stop position or condition, for example in which the valve means may be biased thereagainst, e.g. and inhibited from moving or opening or closing, and an undeployed or retracted or release or released or open or broken or severed or changed position or condition, e.g. in which the valve means may be able to open or close or move uninhibited.

In some embodiments, the release means or abutment means comprises a breakable or frangible or severable element or member or bulb, e.g. a glass bulb, against which the valve means abuts, for example wherein the valve member is caused or allowed or permitted to move or change to the open or closed position or condition when the breakable or frangible or severable element or member or bulb is broken or severed.

In some embodiments, one or more or each of the first and/or second and/or third opening means comprises an or a respective activation means, e.g. for operating the release means or the abutment means or for causing it to break or to move or change between the deployed or stop position or condition and the undeployed or retracted or release or released or open position or condition. One or each of first and/or second opening or activation means may comprise a striking element or edge or surface, which may be operable or movable to strike or move the release means or abutment means, e.g. the breakable or frangible or severable element or member or bulb, such as in response to the actuation of one of or a respective one of the first and second actuators. The striking element of the first opening or activation means may be electrically or percussively or explosively or electromechanically or electromagnetically or pneumatically or hydraulically activated or operated or propelled or moved to strike or move the release means or abutment means, e.g. wherein the first actuator comprises an input or button or switch for activating the activation means or percussive or explosive or electromechanical or electromagnetic or pneumatic or hydraulic activation or operation or propulsion or propelling means or force. In some embodiments, the first opening or activation means comprises a percussive or explosive charge and/or a servo actuator, for example which preferably drives the striking element to strike or move the release means or abutment means. The striking element of the second opening or activation means may be mechanically activated or operated or moved to strike or move the release means or abutment means.

In embodiments, the striking element of the second opening or activation means is biased toward the release means or abutment means, for example by a biasing means or a resilient biasing means such as a spring, and may be retained, e.g. in a retracted position or condition, by a manual release means or abutment means such as a retaining element or pin that may be movable or removable by the second actuator. The retaining element may be movable or removable, for example between or from a deployed or inserted or present position or condition, e.g. in which movement of the second striking element is inhibited, and or to a retracted or removed position or condition, e.g. in which the second striking element is able to move, for example under a resilient and/or spring bias, toward the release means or element. The retaining element may selectively abut an abutment surface and/or may be removably received within a recess or depression or hole or aperture, which may comprise the abutment surface and/or be in the striking element or in a member or element or piston that includes the striking element. The abutment surface or recess or depression or hole or aperture may extend perpendicularly with respect to the striking direction or direction of movement of the striking element. The second actuator may comprise a handle for moving the retaining element from the deployed position to the retracted position or for removing the retaining element, e.g. thereby allowing the striking element to move.

In some embodiments, the valve assembly further comprises a safety means or element, such as a pin, e.g. a safety pin, which may selectively prevent operation of the striking means or element or elements, e.g. the second striking element. The safety means or element may abut a or a further abutment surface and/or may be removably received within a or a further recess or depression or hole or aperture, which may comprise the or the further abutment surface, in the striking element or in a piston that includes the striking element.

Additionally or alternatively, the third opening or activation means may comprise an environmental or thermal activation means that may be configured to operate the release means, e.g. when exposed to one or more predetermined environmental conditions, such as a predetermined temperature and/or pressure, or when one or more predetermined environmental conditions, e.g. temperature and/or pressure, is present or exceeded. In some embodiments, the release means comprises the or a breakable or frangible or severable chamber or bulb, for example with an activation element contained therein, such as an expandable substance or fluid, e.g. thereby providing the third opening or activation means. The bulb may be exposed to the surrounding air, for example by a window.

The release means or abutment means may additionally or alternatively comprise or be comprised in the third opening means.

A further aspect of the invention provides a fire suppression device or system comprising a valve assembly as described above. A yet further aspect of the invention provides a vehicle comprising a fire suppression device or system or valve assembly as described above.

For the avoidance of doubt, any of the features described herein apply equally to any aspect of the invention.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one aspect or embodiment of the invention is applicable to all aspects or embodiments, unless such features are incompatible.

### BRIEF DESCRIPTION OF THE DRAWINGS

Embodiments of the invention will now be described by way of example only with reference to the accompanying drawings in which:

FIG. 1 is a schematic representation of a fire suppression system valve assembly according to an embodiment of the invention in an assembled condition;

FIG. 2 is an exploded view of the valve assembly of FIG. 1;

FIG. 3 is a schematic view of a fire suppression system incorporating the valve assembly of FIGS. 1 and 2;

FIG. 4 is an exploded view of a valve assembly according to an alternative embodiment of the invention; and

FIG. 5 is a plan view of a vehicle comprising a fire suppression system incorporating a valve assembly according to an embodiment of the invention.

### DETAILED DESCRIPTION OF THE INVENTION

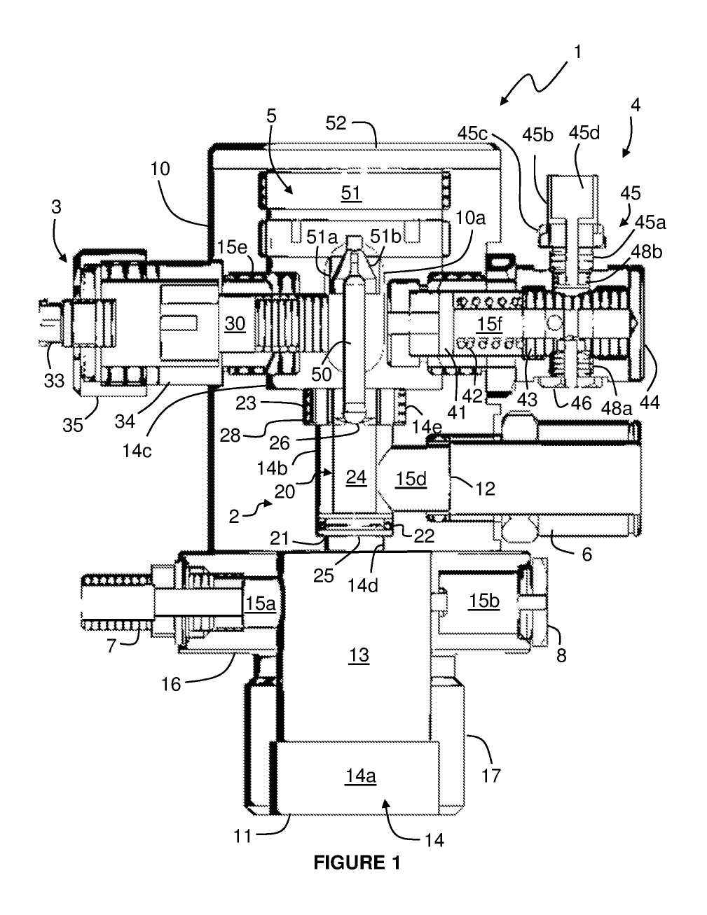

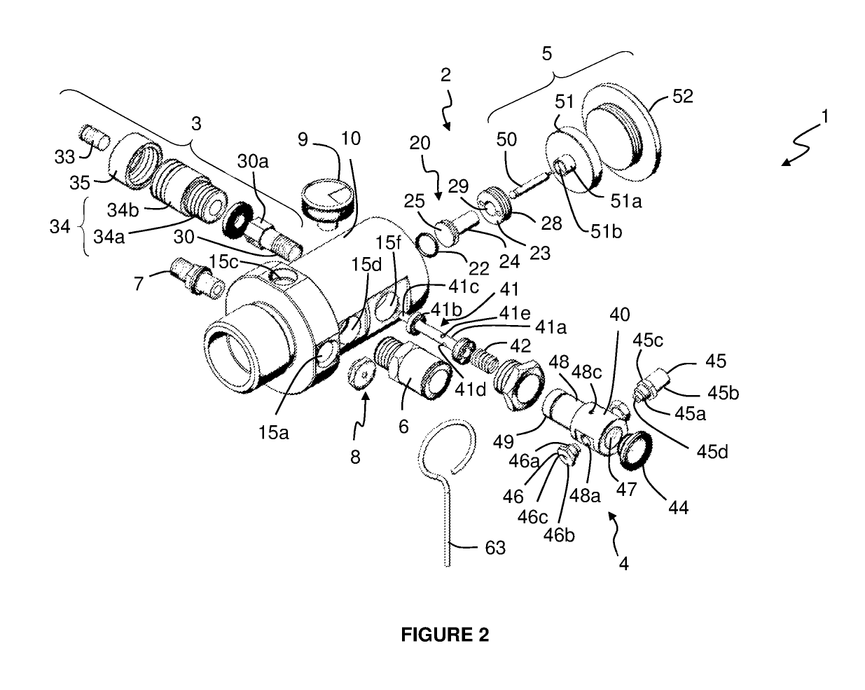

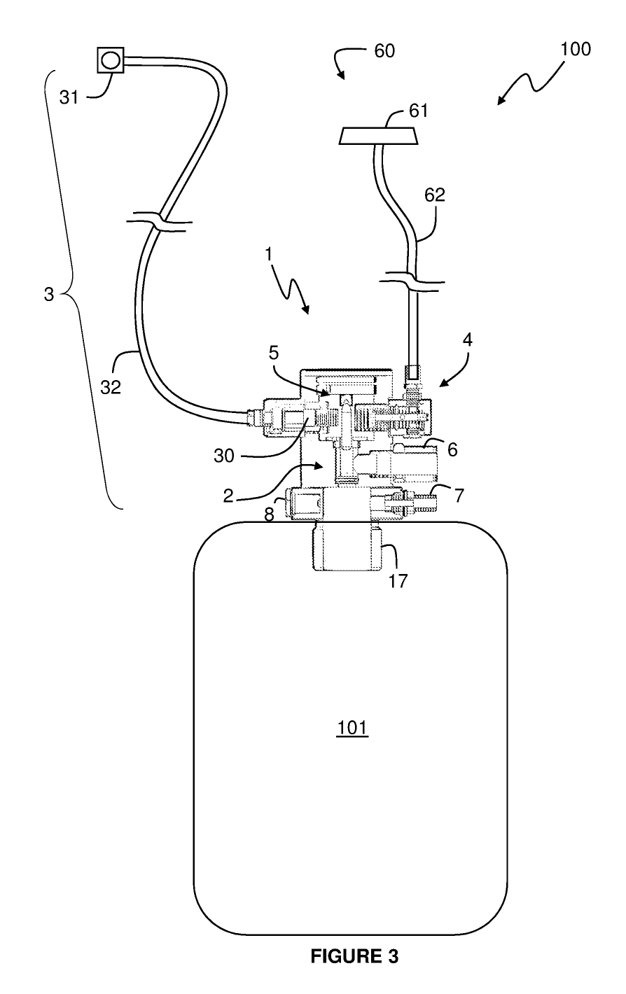

Referring now to FIGS. 1 and 2, there is shown a valve assembly 1 according to an embodiment of the invention for incorporation into a fire suppression system 100 as illustrated in FIG. 3. The valve assembly 1 includes a body 10 with a window 10a, an inlet 11, an outlet 12, a passageway 13 extending between the inlet 11 and the outlet 12, a valve 2 for selectively closing the passageway 13, a first valve activation assembly 3, a second valve activation assembly 4 and a thermal activation assembly 5.

The body 10 is cylindrical with an axial bore 14, six radial bores 15a, 15b, 15c, 15d, 15e, 15f and a circumferential flange 16 intermediate the ends of the body 10. The axial bore 14 includes an inlet portion 14a, a valve portion 14b and an activation portion 14c. The inlet portion 14a and the activation portion 14c are relatively wide and at opposite ends of the body 10, while the valve portion 14b has a smaller diameter than the inlet and activation portions 14a, 14c and extends therebetween. The valve portion 14b also includes a shoulder 14d at its intersection with the inlet portion 14a and a threaded portion 14e at its intersection with the activation portion 14c.

The body 10 also includes a threaded spigot 17 surrounding the inlet portion 14a of the axial bore 14 with a free end that defines the inlet 11. One of the radial bores 15d extends into the valve portion 14b of the axial bore 14 in a central portion of the body 10, which defines the outlet 12 and receives and threadedly engages an outlet fitting 6. The outlet radial bore 15d, together with the valve portion 14b and the inlet portion 14a of the axial bore 14 define the passageway 13. Three of the radial bores 15a, 15b, 15c extend into the circumferential flange 16, a first and a second of which radial bores 15a, 15b are radially aligned with the outlet axial bore 15d and on opposite sides of the flange 16 from one another, while a third radial bore 15c extends perpendicularly with respect to thereto. All three of the radial bores 15a, 15b, 15c extend into the inlet portion 14a of the axial bore 14 between the inlet 11 and the outlet 12. The first radial bore 15a provides a fill port that receives and threadedly engages a Schrader valve 7, while the second radial bore 15b receives and threadedly engages a pressure release valve 8 and the third radial bore 15c provides a gauge port that receives and threadedly engages a pressure gauge 9. The fifth and sixth radial bores 15e, 15f are both adjacent the other end of the body 10, are aligned axially with the first and second radial bores 15a, 15b and are on opposite sides of the body 10. Each of the fifth and sixth radial bores 15e, 15f extends into the activation portion 14c of the axial bore 14 and provides a respective valve activation port.

The valve 2 includes a valve member 20, a valve seat 21, an O-ring seal 22 and a guide ring 23. The valve member 20 includes a cylindrical rod portion 24 with an enlarged piston head 25 at a first of its ends and a hemispherical recess 26 in its second end. The piston head 25 includes a circumferential groove within which is received the O-ring seal 22. The valve seat 21 is provided by a radial surface on the downstream side of the shoulder 14d of the valve portion 14b of the axial bore 14 of the body 10. The guide ring 23 includes an external thread 28 for engaging the threaded end 14e of the valve portion 14b of the axial bore 14 of the body 10 and a central hole 29 sized to receive the second end of the rod portion 24 of the valve member 20. In the assembled condition shown in FIG. 1, the valve member 20 is located within the valve portion 14b of the axial bore 14 of the body 10 such that the piston head 25 abuts the valve seat 21 and the second end of the rod portion 24 is slidably received within the central hole 29 of the guide ring 23.

The first valve actuation assembly 3 includes a percussive charge cartridge 30 that is activated by a remote input device 31 operatively connected to the cartridge 30 by an electrical cable 32 via a connector 33. The cartridge 30 is substantially cylindrical with an oversized hexagonal head 30a and contains a striking element (not shown). The cartridge 30 is received within an adaptor 34 that has a stepped internal bore against which step the head 30a of the cartridge 30 abuts. The adaptor 34 includes an undersized portion 34a, which houses the cylindrical portion of the cartridge 30 and includes an external thread that is received within and engages the fifth threaded radial bore 15e of the body 10. The adaptor 34 also includes a main body portion 34b, which houses the head 30a of the cartridge 30 and includes an external thread at its end. An end cap 35 with an internal thread engages the thread on the main body portion 34b of the adaptor 34 and receives the connector 33, thereby captivating the head 30a of the cartridge 30 between the connector 33 and the step in the adaptor 34. In this embodiment, the percussive charge cartridge 30 contains an explosive material to propel the striking element (not shown). Whilst the first valve actuation assembly 3 incorporates a percussive charge in this embodiment, the skilled person would readily appreciate that the striking element may be propelled or powered by any number of alternative means, such as hydraulics, pneumatics or some other electromechanical or electromagnetic arrangement.

The second valve activation assembly 4 includes a housing 40, a striking element 41, a spring 42, a stopper 43, an end cap 44 and first and second rod guide fittings 45, 46. The housing 40 is cylindrical with an axial bore 47, a main body portion 48 and a threaded spigot portion 49. The end cap 44 engages a threaded end of the axial bore 47 in the main body portion 48. The main body portion 48 includes first and second opposed, threaded radial bores 48a, 48b adjacent the threaded end of the axial bore 47 and a radial hole 48c adjacent its other end. The striking element 41 includes a rod portion 41a with a piston head 41b at one end and a striking pin 41c projecting from the opposite side of the piston head 41b to the rod portion 41a. The rod portion 41a includes a first radial hole 41d adjacent its free end and a second radial hole 41e through its centre that extends perpendicularly with respect to the first hole 41d. The first rod guide fitting 45 includes a first, threaded end portion 45a, a second, connector portion 45b and a central hexagonal flange 45c between the first and second portions 45a, 45b. The first rod guide fitting 45 also includes an axial hole 45d with a first diameter in the first end portion 45a and the central flange 45c and with a second, larger diameter in the second end portion 45b. The second rod guide fitting 46 includes threaded spigot 46a extending from a hexagonal flange 46b and an axial through hole 46c.

In the assembled condition shown in FIG. 1, the striking element 41 is slidably received within the axial bore 47 of the housing 40 with the piston head 41b and striking pin 41c both in the spigot portion 49, with the second radial hole 41e aligned with the radial hole 48c in the housing 40 and with the first radial hole 41d aligned with the first and second radial bores 48a, 48b in the housing 40. A manual release member 60 is provided that includes a handle 61 and a cable slidable within a sheath 62 received by and sized to fit snugly within the connector portion 45b of the first rod guide fitting 45. The cable (not shown) is received by and sized to fit snugly within the axial holes 45d, 46c of the first and second rod guide fittings 45, 46 respectively. A safety pin 63 is received within the third radial bore 48c in the housing 40 and extends through the second radial hole 41e of the striking element 41. The stopper 43 includes an external thread and is received and threadedly engaged within the axial bore 47 of the housing 40 with the spring 42 captivated between the stopper 43 and the piston head 41b of the striking element. The threaded spigot portion 49 is received within and engages the sixth threaded radial bore 15f of the body 10. Thus, the striking element 41 is resiliently urged into the body 10, but retained or held back by the manual release member 60 and the safety pin 61 which extend through a respective one of the radial holes 41d, 41e.

The thermal valve activation assembly 5 includes a breakable glass bulb 50, a retainer 51 and an end cap 52. The bulb 50 contains a substance that expands when heated and that is configured to break or shatter the bulb 50 at a predetermined temperature. The retainer 51 includes a spigot portion 51a with a conical recess 51b on one of its sides for receiving and retaining a conical end of the bulb 50. In an assembled condition as shown in FIG. 1, the bulb 50 and retainer 51 are received within the activation portion 14c of the axial bore 14 of the body 10 and retained therein by the end cap 52. The bulb 50 is captivated between the conical recess 51b of the retainer 51 and the hemispherical recess 26 in the rod portion 24 of the valve member 20. The window 10a is aligned with the captivated bulb 50 and exposes the bulb 50 to the surrounding air to ensure that it shatters in the event of a fire.

As shown in FIG. 3, the valve assembly 1 is operatively connected to a pressurised vessel 101 containing a fire retardant material by a threaded connection between the threaded spigot 17 of the body 10 and a threaded hole of the pressurised vessel 101. The pressure within the vessel 6 urges the piston head 25 of the valve member 20 upward, away from the valve seat 21, but its movement is prevented by the bulb 50. It should be noted that the valve 2 seals the passageway 13 by virtue of the O-ring seal 22, rather than by cooperation between the valve head 25 and the valve seat 21.

In use, the valve 2 is opened by breaking the bulb 50, which can be achieved in one of three ways. First, the remote input device 31 may be actuated, which sends an electrical activation signal through the cable 32 to the percussive charge cartridge 30, thereby to ignite the explosive charge contained therein, which propels the striking element 33 of the first valve actuation assembly 3 toward the bulb 50, thereby striking and shattering the bulb 50. Second, with the safety pin 61 removed, the handle of the manual release member 60 may be pulled, thereby removing the cable (not shown) from the striking element 41 of the second activation assembly 4, which is then released to be propelled by the spring 42 toward the bulb 50, thereby striking and shattering the bulb 50. Third, the bulb 50 may be broken by the environmental temperature reaching the predetermined temperature required for the expandable substance within the bulb 50 to cause it to shatter.

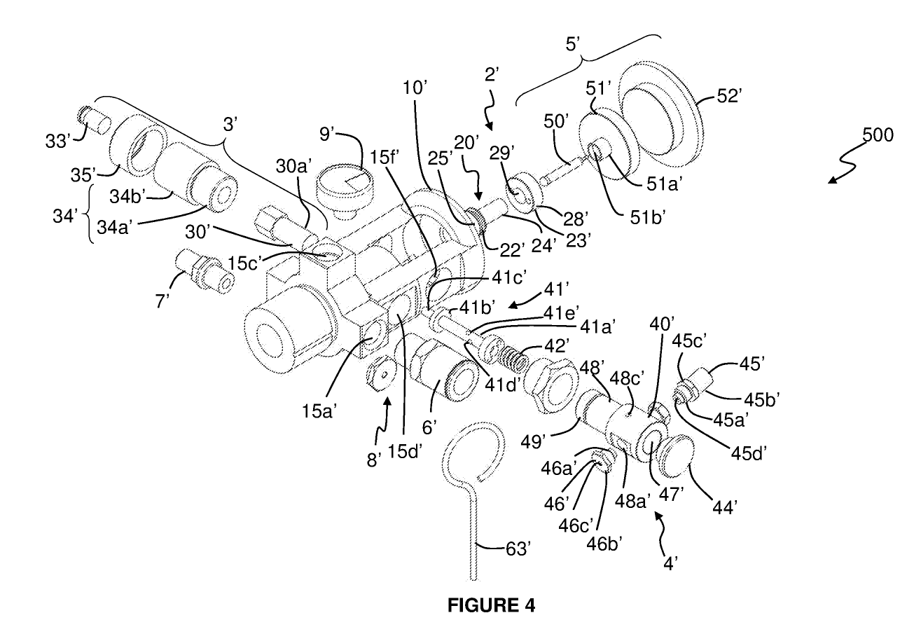

Referring now to FIG. 4, there is shown a valve assembly 500 according to an alternative embodiment of the invention, wherein like references (followed by a prime (′)) refer to like features which will not be described herein further. The valve assembly 500 shown in FIG. 4 differs from the valve assembly 1 shown in FIGS. 1 and 2 in that the body 10′ further comprises plural rebates designed to remove material therefrom. Advantageously, the body 10′ of valve assembly 500 requires relatively less material than the body 10 of valve assembly 1. Consequently, the valve assembly 500 is relatively lighter and may be manufactured at relatively reduced expense.

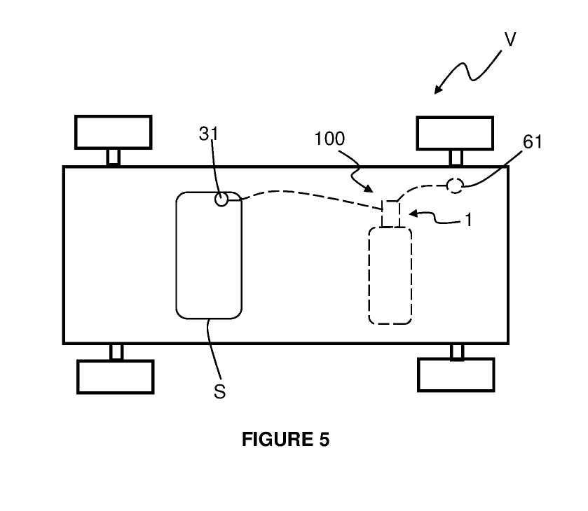

Referring now to FIG. 5, there is shown a fire suppression system 100 installed in a vehicle V, where the fire suppression system comprises a valve assembly 1. The remote input device 31 is accessible by an occupant of the vehicle V within a seating area S. In embodiments the remote input device 31 may be positioned in any other suitable location.

It will be appreciated by those skilled in the art that several variations to the aforementioned embodiments are envisaged without departing from the scope of the invention. For example, the first valve actuation assembly 3 may be powered by any number of alternative means, such as hydraulics, pneumatics or some other electromechanical or electromagnetic arrangement. Similarly, the second valve actuation assembly 4 and the thermal valve activation assembly 5 may each comprise one of any number of arrangements that would be apparent to the skilled person. Moreover, the bulb 50 may be replaced with a different element, such as a severable or movable member or any other suitable arrangement. Additionally or alternatively, the fire suppression system 100 shown in FIG. 3 may incorporate the valve assembly 500 shown in FIG. 4. Additionally or alternatively, the fire suppression system 100 installed in a vehicle V shown in FIG. 5 may incorporate the valve assembly 500 shown in FIG. 4.

It will also be appreciated by those skilled in the art that any number of combinations of the aforementioned features and/or those shown in the appended drawings provide clear advantages over the prior art and are therefore within the scope of the invention described herein.

What is claimed is:

1. A valve assembly for controlling the release or delivery of a fire suppression medium from a vessel, the assembly comprising an inlet connectable to a pressurised vessel, an outlet connectable to a delivery device, a valve operable to selectively open or close fluid communication between the inlet and the outlet, an opening device for moving the valve from a closed condition to an open condition, first and second actuators and an environmental triggering device, wherein the opening device is operable, in use, remotely by the first actuator or manually by the second actuator or automatically by the environmental triggering device.

2. Valve assembly according to claim 1, wherein the first actuator operates or triggers the opening device electrically or by a fluid.

3. Valve assembly according to claim 1, wherein the second actuator operates the opening device mechanically or by a cable or rod.

4. Valve assembly according to claim 1, wherein the valve is biased toward the open condition, the opening device comprising a release device selectively retaining the valve in the closed condition.

5. Valve assembly according to claim 4, wherein the release device comprises a release element movable or breakable, in use, in response to the actuation of one of the first and second actuators or in response to the activation of the environmental triggering device.

6. Valve assembly according to claim 5, wherein the release element comprises a breakable bulb containing an expandable substance that provides the environmental triggering device.

7. Valve assembly according to claim 5, wherein the opening device comprises a striking device operable in response to the actuation of one of the first and second actuators to strike or move the release element.

8. Valve assembly according to claim 7, wherein the striking device comprises first and second striking elements each being operable in response to the actuation of a respective one of the first and second actuators to strike or move the release element.

9. Valve assembly according to claim 8, wherein the first striking element is propelled, in use, by a percussive or explosive charge.

10. Valve assembly according to claim 8, wherein the first striking element is propelled, in use, by an electromechanical or electromagnetic or pneumatic or hydraulic force.

11. Valve assembly according to claim 9, wherein the first actuator comprises an input device for electrically activating the charge or force.

12. Valve assembly according to claim 8, further comprising a retaining element movable or removable by the second actuator, wherein the second striking element is biased toward the release element and retained in a retracted position by the retaining element.

13. Valve assembly according to claim 12, wherein the retaining element is movable or removable from a deployed or inserted condition in which movement of the second striking element is inhibited to a retracted or removed condition in which the second striking element is able to move under a spring bias toward the release element.

14. Valve assembly according to claim 13, wherein the second actuator comprises a handle for moving the retaining element from the deployed position to the retracted position or for removing the retaining element.

15. Valve assembly according to claim 7, further comprising a safety element for selectively preventing operation of the striking device.

16. Valve assembly according to claim 8, further comprising a safety element for selectively preventing the movement of the second striking element.

17. A fire suppression system comprising a valve assembly according to claim 1.

18. A vehicle comprising a fire suppression system according to claim 17.
